(19) United States
(12) Patent Application Publication
(10) Pub. No.: US 2012/0158297 A1
(43) Pub. Date: Jun. 21, 2012

(54) INDOOR LOCATION RECOGNITION SYSTEM AND INDOOR LOCATION RECOGNITION METHOD USING THE SAME

(75) Inventors: Jae Ho Kim, Daejeon (KR); Sang Ho Lee, Daejeon (KR); Yeong Jin Kim, Daejeon (KR)

(73) Assignee: Electronics and Telecommunications Research Institute, Daejeon (KR)

(21) Appl. No.: 13/332,147

(22) Filed: Dec. 20, 2011

(30) Foreign Application Priority Data
Dec. 20, 2010 (KR) 10-2010-0130748

(51) Int. Cl. G01C 21/00

(52) U.S. Cl. 701/516

(57) ABSTRACT

Disclosed is an indoor location recognition system capable of providing location based services indoors. The indoor location recognition system includes a portable terminal including a short range location recognition system and a wireless communication system using an RFID technology and a two-dimensional bar code technology, a geomagnetic sensor, a camera, an RFID reader or tag, an indoor navigation device calculating a moving distance from revolutions of a wheel of a shopping cart to transmit the calculated moving distance to the portable terminal, shopping mall map information transmitted to the portable terminal, and shopping mall application programs providing location based services. The shopping mall to which the indoor location recognition system according to the exemplary embodiments of the present invention is applied can reduce initial installation costs and operation costs while providing high accuracy of location estimation.

### CROSS-REFERENCE TO RELATED APPLICATION

This application claims priority under 35 U.S.C. §119 to Korean Patent Application No. 10-2010-0130748, filed on Dec. 20, 2010, in the Korean Intellectual Property Office, the disclosure of which is incorporated herein by reference in its entirety.

### TECHNICAL FIELD

The present invention relates to an indoor location recognition system and an indoor location recognition method using the same, and more particularly, to an indoor location recognition system providing location based services through location recognition and tracking of users in the indoor and an indoor location recognition method using the same.

### BACKGROUND

A location based service (LBS) is a service that detects a location of a user using a localization technology and provides various information or services based on the detected results.

In recent years, research into the location based service has been actively conducted due to appearance of smart phones having functions such as GPS, a geomagnetic sensor, a camera, RFID, or the like.

The location based service researched from the past has been widely used for an outdoor localization system such as a localization technology using GPS and a mobile communication network, a localization technology based on a wireless LAN signal pattern matching algorithm, or the like.

However, the outdoor localization system is not appropriate for an indoor environment requiring high accuracy of location estimation. The reason is that the outdoor localization system secures appropriate performance outdoors but is difficult to accurately perform the indoor localization indoors due to influences, such as signal interference, or the like, due to indoor structures, for example, a wall, or the like.

An indoor localization system based on RFID, infrared rays, ultrasonic waves, ultra wideband, or the like, and an indoor localization system using a camera have been proposed for indoor localization, but are not difficult to be commercialized due to the increase in initial installing costs and operation costs.

### SUMMARY

An exemplary embodiment of the present invention provides an indoor location recognition system, including: a location recognizing sensor disposed at any location of the indoor space to serve as a reader, recognizing a portable terminal of the user as a tag for location identification, and generating the identifier information according to the recognized results; an indoor navigation device installed in an indoor transport unit moved by the user in the indoor space to measure a movement distance and a movement direction of the indoor transport unit and transmitting the measured results as movement distance information and movement direction information of the portable terminal to the portable terminal; and a web server receiving the identifier information to transmit present location information of the portable terminal to the portable terminal, receiving information generated by updating the present location information based on the movement distance information and the movement direction information from the portable terminal, and recognizing the location of the user moving in the indoor space in real time based on the updated information to provide the location based service to the portable terminal.

Another exemplary embodiment of the present invention provides an indoor location recognition system, including: a location identification tag disposed at any location of the indoor space; a portable terminal serving as a reader recognizing the location identification tag and generating the identifier information according to the recognized results; an indoor navigation device installed in an indoor transport unit moved by the user in the indoor space to measure a movement distance and a movement direction of the indoor transport unit and transmitting the measured results as movement distance information and movement direction information of the portable terminal to the portable terminal; and a web server receiving the identifier information from the portable terminal to analyze present location coordinate information of the portable terminal, transmitting the analyzed present location coordinate information to the portable terminal, receiving information generated by updating the present location coordinate information based on the movement distance information and the movement direction information from the portable terminal, and recognizing the location of the user moving in the indoor space in real time based on the updated information to provide the location based service to the portable terminal.

Yet another exemplary embodiment of the present invention provides a network-based indoor location recognition method, the method including: recognizing, in a location recognizing sensor disposed at any location of the indoor space, a portable terminal of the user as a tag for location identification to transmit the identifier information to a web server providing the location based service; transmitting, in the web server, present location information of the portable terminal to the portable terminal in response to the identifier information; measuring, in an indoor navigation device installed in an indoor transport unit moving in the indoor space by the user possessing the portable terminal, a movement distance and a movement direction of the indoor transport unit and transmitting the measured results to the portable terminal; updating, in the portable terminal, the present location using the present location information and the measured results and transmitting the updated present location information to the web server; and transmitting, in the web server, the location based service to the portable terminal according to the updated present location information.

Still another exemplary embodiment of the present invention provides an a handset-based indoor location recognition method, the method including: recognizing, in a portable terminal of the user, a location identification tag disposed at any location of the indoor space to transmit the identifier information to a web server providing the location based service; transmitting, in the web server, present location information of the portable terminal to the portable terminal in response to the identifier information; measuring, in an indoor navigation device installed in an indoor transport unit moving in the indoor space by the user possessing the portable terminal, a movement distance and a movement direction of the indoor transport unit and transmitting the measured results to the portable terminal; updating, in the portable terminal, the present location using the present location information and the measured results and transmitting the updated present location information to the web server; and transmitting, in the web server, the location based service to the portable terminal according to the updated present location information.

Other features and aspects will be apparent from the following detailed description, the drawings, and the claims.

### BRIEF DESCRIPTION OF THE DRAWINGS

FIG. 1 is an overall configuration diagram of an indoor location recognition system according to an exemplary embodiment of the present invention.

FIG. 2 is a plan view of one floor of a shopping mall showing a place at which the indoor location recognition apparatus shown FIG. 1 is disposed.

FIG. 3 is a block diagram showing an inner configuration of an indoor navigation device shown FIG. 1.

FIG. 4 is a block diagram showing an example of an inner configuration of a portable terminal shown FIG. 1.

FIG. 5 is a conceptual diagram showing an indoor location recognition procedure using the indoor location recognition system shown in FIG. 1.

FIG. 6 is a conceptual diagram showing an indoor location recognition and tracking procedure using the indoor location recognition system shown in FIG. 1.

FIG. 7 is a flow chart showing a method of providing network-based location recognition and location based services using the location recognition system shown in FIG. 1.

FIG. 8 is a flow chart showing a method of providing handset-based location recognition and location based services using the location recognition system shown in FIG. 1.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The present invention relates to an indoor location recognition system capable of providing a location based service indoors, and may include a short distance location recognition system using a RFID technology and a two-dimensional bar code technology, a wireless communication system, a portable terminal including a geomagnetic sensor, a camera, an RFID reader or tag, an indoor navigation device calculating moving distance from the revolutions of a wheel of a shopping cart and transmitting the moving distance to the portable terminal, and an application program executing map information of the shopping mall and the location based service transmitted to the portable terminal. The indoor location recognition system of the present invention may lower initial installing costs and operation costs, and simultaneously, provide high accuracy of location estimation.

Hereinafter, an exemplary embodiment of the present invention will be described in detail with reference to the accompanying drawings.

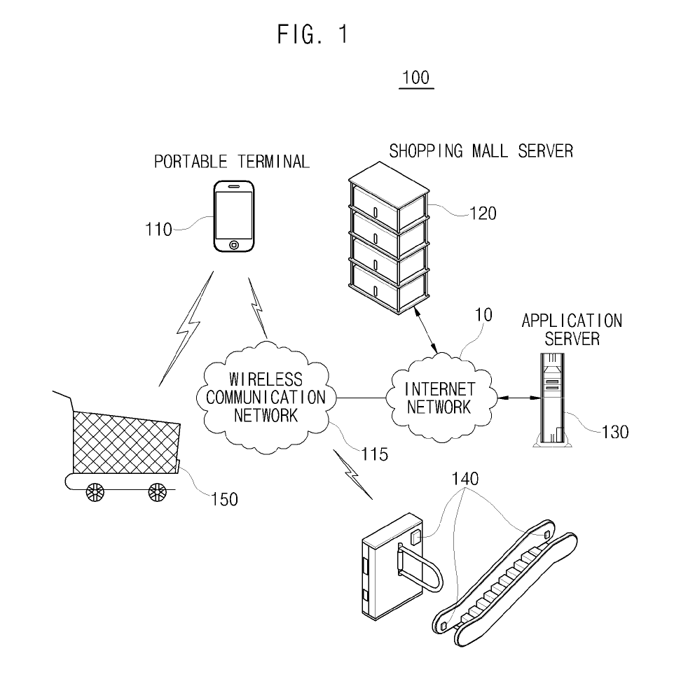

FIG. 1 is an overall configuration diagram of an indoor location recognition system according to an exemplary embodiment of the present invention.

Referring to FIG. 1, the indoor location recognition system according to an exemplary embodiment of the present invention provides the location based service in an indoor space of a large shopping mall. However, the embodiments of the present invention are presented to only assist understanding of the present invention, and the indoor location recognition system of the present invention may be applied to various structures forming the indoor space as well as the indoor space such as the large shopping mall.

The indoor location recognition system 100 according to an exemplary embodiment of the present invention includes a portable terminal 110, a shopping mall server 120, an application server 130, an indoor location recognition device 140, and an indoor navigation device 150.

The portable terminal 110 may basically perform video and voice calls through mobile communication networks and may wirelessly communicate with the indoor location recognition device 140 and the indoor navigation device 150 through the wireless communication system 115. The portable terminal 110 may access a server of the shopping mall and the application server through the wireless communication system 115 and Internet network 10. The portable terminal 110 is equipped with a mobile OS to allow a user to access a web site on the move and download various application programs and various contents, which may be 3G mobile devices. Further, basically, the portable terminal 110 may further include a wireless communication interface module, a RFID (Radio-Frequency IDentification) module, a camera module, a geomagnetic sensor module and the like so as to provide the location based service indoors.

The shopping mall server 120 provides the various application programs of the shopping mall relating to the shopping mall to the application server 130 through the Internet 10. Further, the shopping mall server 120 may transmit the map information within the shopping mall, goods information representing a price and a type of the goods sold in the shopping mall and the like to the portable terminal 110 through the Internet 10 and the wireless communication system 115 so as to provide the location based service.

The application server 130 as a type of portal server transmits (downloads) the various application programs of the shopping mall transmitted from the shopping mall server 120 to the portable terminal 110. Here, the various application programs of the shopping mall may be directly transmitted (downloaded) to the portable terminal 110 from the shopping mall server 120 without passing the application server 130

When the portable terminal 110 directly downloads the various application programs of the shopping mall from the shopping mall server 120, a tedious procedure (for example, the log in process) in which the potable terminal 110 accesses the shopping mall server to download the application program of the shopping mall may be required, such that it is desirable that the portable terminal may receive the application programs from the application server functioning as a portable server that does not require such an access process.

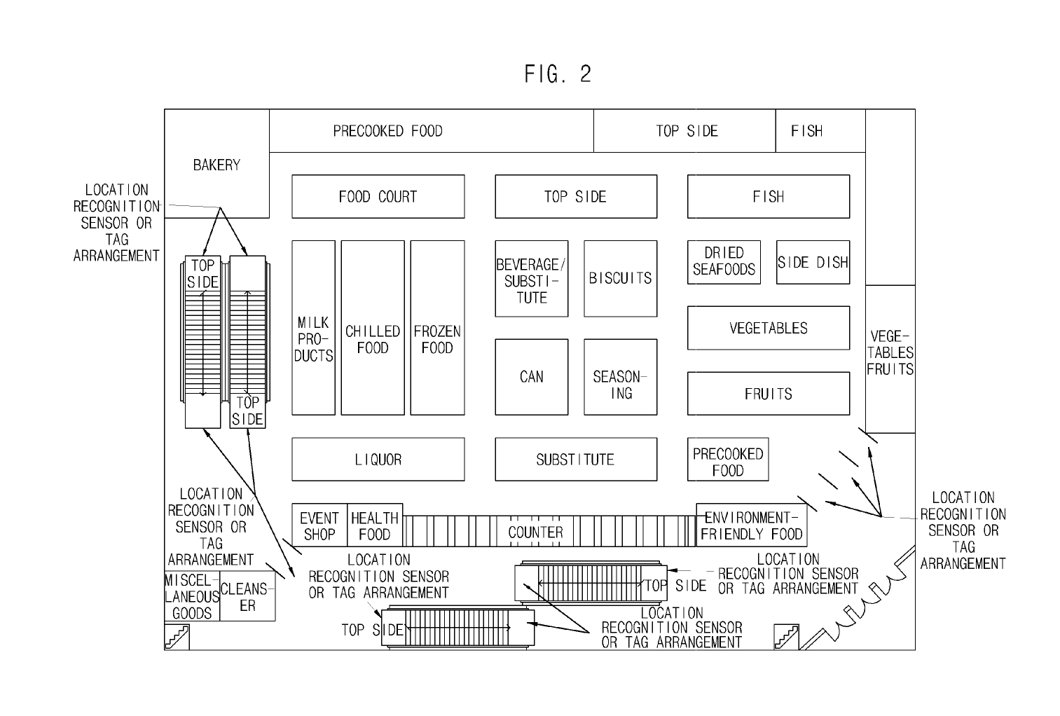

As shown in FIG. 2, the indoor location recognition device 140 may be disposed at the place through which the user who visits the shopping mall has to pass, for example, the entrance and exit locations for inter-floor transport unit such as doors, elevators or moving walks, and may wirelessly communicate with the potable terminal 110 through the wireless communication system 115. The indoor location recognition device 140 may be implemented by various location recognition sensors or location identification tags (or RFID tag) capable of wirelessly communicating with the portable terminal 110 owned by the user so as to recognize the location of the user. Meanwhile, the indoor location recognition device is marked by a location recognition sensor in the accompanying claims.

The indoor navigation device 150 may be installed in an indoor transport unit such as shopping cart disposed inside the shopping mall and wirelessly communicate with the portable terminal 110 through the wireless communication system 115. To this end, a wireless communication interface module may be provided inside the indoor navigation device 150.

FIG. 2 is a plan view of one floor of a shopping mall showing a place at which the indoor location recognition apparatus shown FIG. 1 is disposed.

As shown in FIG. 2, the indoor location recognition device (140 of FIG. 1) may be disposed at a place through which the user visiting the shopping mall necessarily passes, for example, the entrance and exit locations of the inter-floor transport unit such as doors, elevators, or moving sidewalks, or the like, and may be implemented by the location recognition sensor or the location identification tag, as described above.

When the indoor location recognition device is implemented by the location recognition sensor, the network-based location recognition technology recognizing the location identifier on the network may be applied. An example of the location recognition sensor may include an RFID reader, a camera, or the like.

Meanwhile, when the indoor location recognition device is implemented by the location identification tag, a handset-based location recognition technology recognizing the location identifier at the terminal may be applied. An example of the location identification tag may include a marker such as an RFID tag, a two-dimensional bar code, or the like.

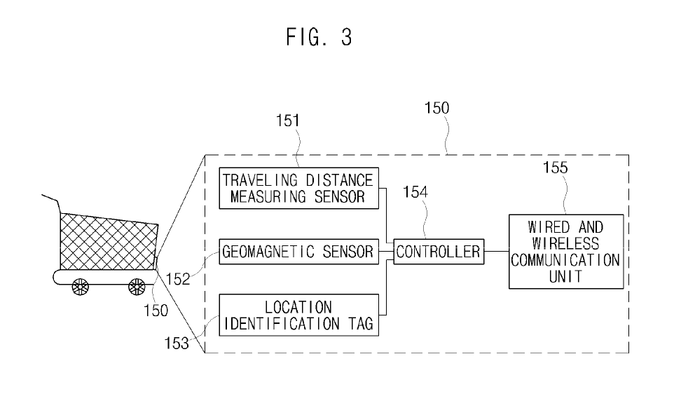

FIG. 3 is a block diagram showing an inner configuration of an indoor navigation device shown FIG. 1.

Referring to FIG. 3, the indoor navigation device 150 is disposed in the indoor transport unit such as the shopping cart disposed in the shopping mall and includes a traveling distance measurement sensor 151, a geomagnetic sensor 152, a location identification tag 153, a controller 154, and a wired and wireless communication unit 155.

The traveling distance measuring sensor 151 calculates a moving distance of the indoor transport unit through the recognition of revolutions of a wheel or a pattern of an indoor bottom surface. When the moving distance is calculated by measuring the revolutions of the wheel, the traveling distance measuring sensor 151 may include a magnet attached to the wheel, a lead switch attached to a support supporting the wheel, and a counter. In this case, when the lead switch is switched once each time the wheel rotates to output the turn-on signal, the counter counts the output turn-on signal to measure the revolutions of the wheel according to the counted result values. When the moving distance is calculated through the pattern recognition of the indoor bottom surface, for example, the traveling distance measuring sensor 151 may include a light emitting device emitting light to the indoor bottom surface and a light receiving unit receiving light reflected from the indoor bottom surface. The indoor bottom surface is not flat at all times and forms any pattern, such that the amount of light reflected from the bottom surface may be slightly changed according to the pattern. Therefore, the light receiving unit recognizes the pattern of the bottom surface as the amount of reflected light. That is, the moving distance of the indoor transport unit may be calculated through the change rate of the amount of light reflected from the indoor bottom surface according to the movement of the indoor transport unit.

The geomagnetic sensor 152 is a unit that measures the moving direction of the indoor transport unit. The geomagnetic sensor 152 may be removed from the inner configuration of the indoor navigation device 150 when the geomagnetic sensor is disposed in the portable terminal 110.

In the exemplary embodiment of the present invention, when the network-based location recognition technology is applied, the location identification tag may be disposed in the indoor navigation device 150.

The controller 154 controls a general operation of the overall block components and controls the measurement period of the moving distance measured by the traveling distance measuring sensor 151 and the measurement period of the moving direction of the indoor transport unit measured by the geomagnetic sensor 152.

The wired and wireless communication unit 154 transmits the measured result values to the portable terminal 110 according to the control of the measurement period of the controller.

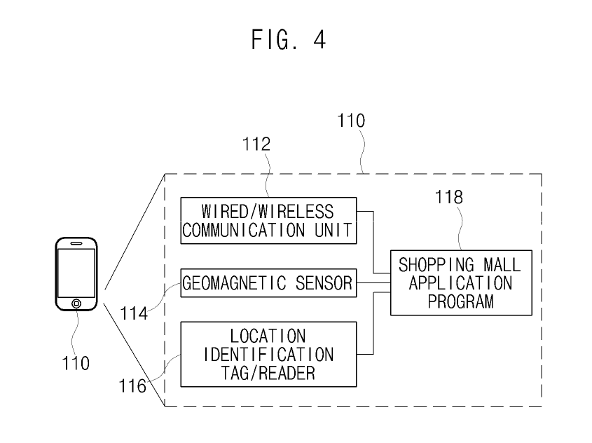

FIG. 4 is a block diagram showing an example of an inner configuration of a portable terminal shown FIG. 1.

Referring to FIG. 4, the portable terminal 110 is a block configuration for the indoor location recognition and tracking and may include a wired and wireless communication unit 112, a geomagnetic sensor 114, a location identification tag/reader unit 116, and a storage medium 118 in which shopping mall application programs are stored.

The wired/wireless communication unit 112 is a module performing an interfacing function with the wireless communication system (115 of FIG. 1) and may periodically receive the moving distance information through the wireless communication system (115 of FIG. 1) from the indoor navigation device (150 of FIGS. 1 and 3) and additionally receive the moving direction information.

The geomagnetic sensor 114 is a sensor that detects a flow of magnetic field generated from the earth to detect orientation and measures the moving direction of the portable terminal based on the detected results. Further, the portable terminal 110 may include the location identification tag or the reader according to the location recognition mechanism.

The shopping mall application programs stored in the storage medium receive the location recognition start coordinates, the moving distance information, and the moving direction information from the indoor location recognition device 140 and the indoor navigation device 150 to calculate the present position of the user.

The calculated user location information may be used as the information for providing various location based services and may be transmitted to the shopping mall server 120 for providing the location based services in the network.

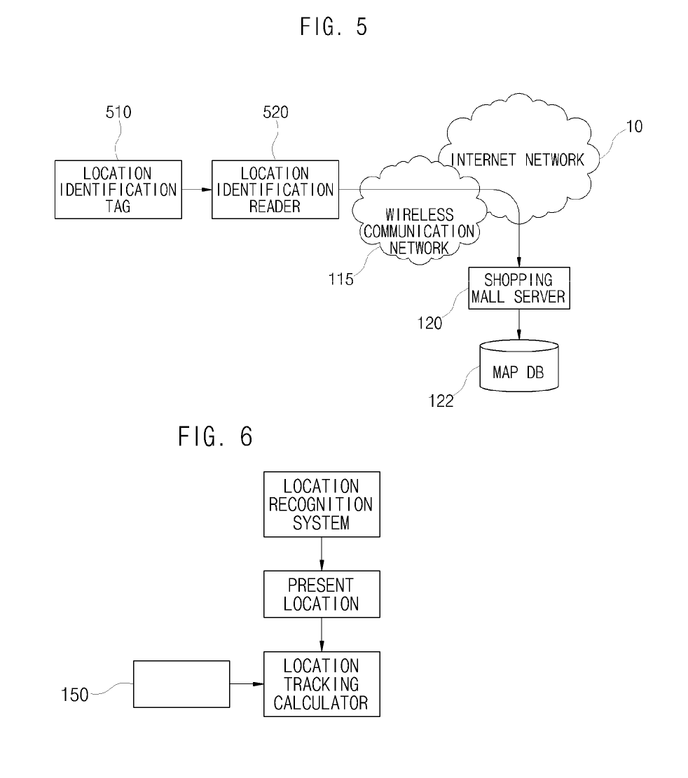

FIG. 5 is a conceptual diagram showing an indoor location recognition procedure using the indoor location recognition system shown in FIG. 1.

Referring to FIG. 5, in the network-based location recognition method according to the exemplary embodiment of the present invention, a location identification tag 510 is disposed in the indoor navigation device 150 or the portable terminal 110. In this case, when the user enters and exits in and from the door or the moving sidewalk in which a location identification reader 520 is disposed, the location identification reader 520 (the location recognition reader may be the portable terminal or the location recognition sensor) reads the identifier information stored in the location identification tag 510 and transmits the read identifier information to the shopping mall server 120 through the Internet network 10 interworking with the wired communication network 115.

The shopping mall server 120 refers to a previously constructed map database 122 (or mapping table) to extract the coordinate values of the corresponding device (portable terminal or location recognition sensor) serving as the location identification reader 520 and transmits the extracted coordinate values as the location information (or the location information of the user) of the portable terminal to the portable terminal 110. Therefore, when the location recognition sensor disposed in the indoor space is the location identification reader 520, the user may recognize the current location of the user when the user enters and exits in and from the door or the moving sidewalk to which the location recognition reader is attached.

In the handset-based location recognition scheme, the portable terminal of the user reads the location identification tag disposed at the door and the moving sidewalk and recognizes the user's location from the read information.

FIG. 6 is a conceptual diagram showing an indoor location recognition and tracking procedure using the indoor location recognition system shown in FIG. 1.

Referring to FIG. 6, the portable terminal 110 or the location tracking calculator in the location server (not shown) disposed at the network periodically receives the moving distance information and the moving direction information from the indoor navigation device 150 based on the location recognition coordinates corresponding to the present location recognized through the location recognition system disposed indoors and calculates the periodically transmitted moving distance information and moving direction information to update the current location of the user.

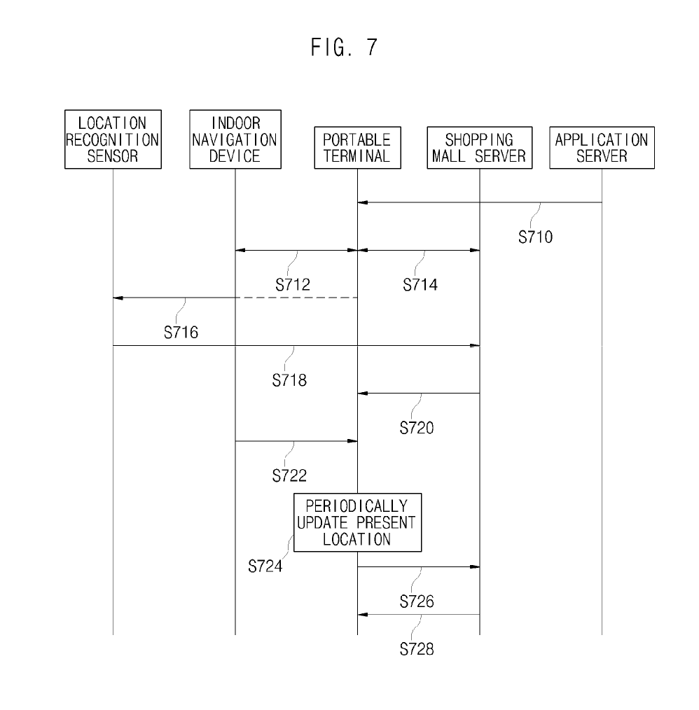

FIG. 7 is a flow chart showing a method of providing network-based location recognition and location based services using the location recognition system shown in FIG. 1.

Referring to FIG. 7, in the network based location recognition and location-based service providing method, the portable terminal downloads from the application server and installs the shopping mall related application programs provided from the shopping mall (S710). In this case, when the user with the portable terminal reaches the corresponding shopping mall, the portable terminal executes the downloaded shopping mall related application programs according to the operation of the user and the portable terminal is held to the indoor transport unit such as the shopping cart.

Then, the portable terminal receives the identifier from the indoor navigation device attached to the shopping cart (S712). By this configuration, a session is configured between the portable terminal and the indoor navigation device. In addition, the portable terminal transmits the identifier received from the indoor navigation device to the shopping mall server through the wired and wireless communication network and the Internet network interworking with the wired and wireless communication network (S714). Thereby, a session is configured between the portable terminal and the shopping mall server (S714). In this case, the shopping mall server maps the portable terminal to the indoor navigation device and manages the portable terminal and the indoor navigation device.

When the user of the portable terminal enters the shopping mall, the location recognition sensor (that is, the position recognition reader) disposed at the door recognizes the location identification tag provided to the indoor navigation device or the portable terminal (S716) and transmits the recognized location identification tag to the shopping mall server (S718).

Thereafter, the shopping mall server transmits the location coordinates to the portable terminal (S720) and the indoor navigation device transmits the moving distance information and the moving direction information to the portable terminal (S722).

Then, the portable terminal uses the location coordinates transmitted from the shopping mall server and the moving distance information and the moving direction information received from the indoor navigation device to periodically update the present location information of the user.

The portable terminal periodically transmits the present location information to the shopping mall server so as to receive the location based services from the shopping mall server (S726) and the shopping mall server provides various location based services based on the present location information transmitted from the portable terminal (S728).

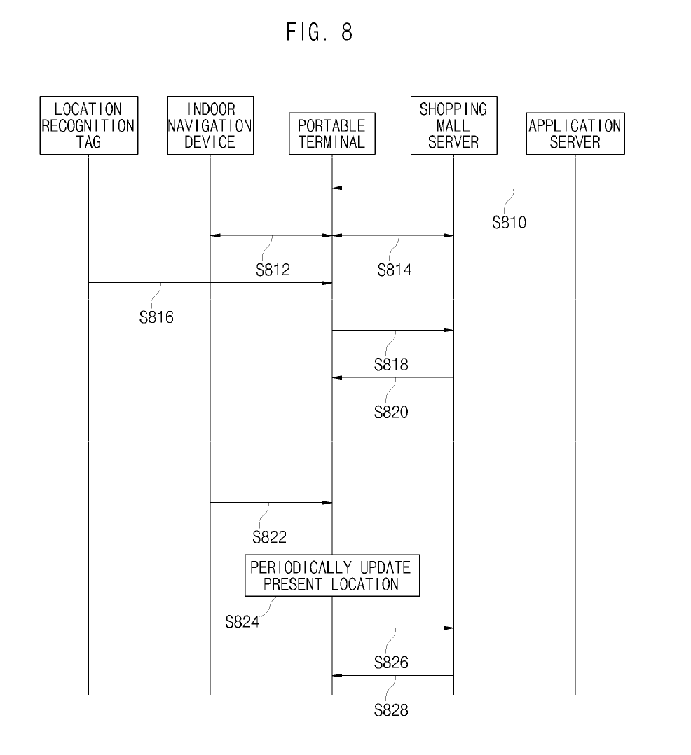

FIG. 8 is a flow chart showing a method of providing handset-based location recognition and location based services using the location recognition system shown in FIG. 1.

Referring to FIG. 8, in the handset-based location recognition and location-based service providing method, the portable terminal downloads from the application server and installs the shopping mall related application programs (S810). Thereafter, when the user of the portable terminal reaches the shopping mall, the portable terminal executes the application programs according to the operation of the user and the portable terminal in which the application programs are being executed is held to the shopping cart.

Thereafter, the session is configured between the portable terminal and the indoor navigation device (S812), similar to the process (S712) of FIG. 7 and the session is configured between the portable terminal and the shopping mall server (S814), similar to the process (S714) of FIG. 7.

Thereafter, when the user enters the shopping mall, the portable terminal recognizes the location identification tag disposed at the door of the shopping mall (S816). In this case, when the portable terminal does not have the map information in the shopping mall, the portable terminal transmits the location identification tag information (hereinafter, identifier information) to the shopping mall server according to the results of recognizing the location identification tag (S818) and the shopping mall server transmits the location coordinate information to the portable terminal in response to the transmitted location identification tag information (S820). Since the shopping mall server includes the database in which the location information corresponding to the corresponding identifier information is constructed in the mapping table form, the shopping mall server receives the corresponding identifier information to extract the corresponding location information and transmits the extracted location information as the present location coordinates (or the present location information) of the portable terminal to the portable terminal.

Then, the moving distance and the moving direction of the indoor transport unit measured by the indoor navigation device are transmitted to the portable terminal as the moving distance information and the moving direction information of the portable terminal (S822) and the portable terminal uses the moving distance information and the moving direction information transmitted from the indoor navigation device to update the present location information transmitted from the shopping mall server (S824). The updated present location information is transmitted to the shopping mall server (S826) and the location based services are provided to the corresponding portable terminal based on the updated present location information transmitted (S828).

As set forth above, the exemplary embodiments of the present invention can provide the high accuracy of location estimation while reducing the initial installing costs and the operation costs.

A number of exemplary embodiments have been described above. Nevertheless, it will be understood that various modifications may be made. For example, although an example in the form of broadcasting service when the image transmission service between the shopping carts is provided from any one shopping cart of shopping carts forming a group to other shopping cart is described in the above-described embodiment, the present invention, of course, may include a group image calling service between the shopping carts. Accordingly, other implementations are within the scope of the following claims.

What is claimed is:

1. An indoor location recognition system for recognizing a location of a user in an indoor space in order to provide a location based service, the system comprising:
a location recognizing sensor disposed at any location of the indoor space to serve as a reader, recognizing a portable terminal of the user as a tag for location identification, and generating the identifier information according to the recognized results;
an indoor navigation device installed in an indoor transport unit moved by the user in the indoor space to measure a movement distance and a movement direction of the indoor transport unit and transmitting the measured results as movement distance information and movement direction information of the portable terminal to the portable terminal; and
a web server receiving the identifier information to transmit present location information of the portable terminal to the portable terminal, receiving information generated by updating the present location information based on the movement distance information and the movement direction information from the portable terminal, and recognizing the location of the user moving in the indoor space in real time based on the updated information to provide the location based service to the portable terminal.

2. The system of claim 1, wherein the location recognizing sensor is disposed at entrance and exit locations of an inter-floor moving device.

3. The system of claim 2, wherein the inter-floor moving device is a door, an elevator, or a moving sidewalk.

4. The system of claim 1, wherein the indoor navigation device includes:
a traveling distance measuring sensor measuring the revolutions of a wheel of the indoor transport unit; and
a geomagnetic sensor measuring the movement direction.

5. The system of claim 4 wherein the traveling distance measuring sensor includes:
a magnet attached to the wheel of the indoor transport unit;
a lead switch attached to a support supporting the wheel to output turn-on signals whenever the wheel rotates; and
a counter receiving and counting the turn-on signals and measuring the revolutions of the wheel based on the counted result value.

6. The system of claim 4, wherein the indoor navigation device further includes a controller controlling measurement periods of the movement distance measured by the traveling distance measuring sensor and the movement direction measured by the geomagnetic sensor.

7. The system of claim 1, wherein the location recognizing sensor and the indoor navigation device communicate with the portable terminal through a wireless communication network built up in the indoor space, and
a shopping mall server communicates with the portable terminal through the wireless communication network and the Internet network interworking with the wireless communication network.

8. An indoor location recognition system for recognizing a location of a user in an indoor space in order to provide a location based service, the system comprising:
a location identification tag disposed at any location of the indoor space; a portable terminal serving as a reader recognizing the location identification tag and generating the identifier information according to the recognized results;
an indoor navigation device installed in an indoor transport unit moved by the user in the indoor space to measure a movement distance and a movement direction of the indoor transport unit and transmitting the measured results as movement distance information and movement direction information of the portable terminal to the portable terminal; and
a web server receiving the identifier information from the portable terminal to analyze present location coordinate information of the portable terminal, transmitting the analyzed present location coordinate information to the portable terminal, receiving information generated by updating the present location coordinate information based on the movement distance information and the movement direction information from the portable terminal, and recognizing the location of the user moving in the indoor space in real time based on the updated information to provide the location based service to the portable terminal.

9. An indoor location recognition method for recognizing a location of a user in an indoor space in order to provide a location based service, the method comprising:
recognizing, in a location recognizing sensor disposed at any location of the indoor space, a portable terminal of the user as a tag for location identification to transmit the identifier information to a web server providing the location based service;
transmitting, in the web server, present location information of the portable terminal to the portable terminal in response to the identifier information; measuring, in an indoor navigation device installed in an indoor transport unit moving in the indoor space by the user possessing the portable terminal, a movement distance and a movement direction of the indoor transport unit and transmitting the measured results to the portable terminal;
updating, in the portable terminal, the present location using the present location information and the measured results and transmitting the updated present location information to the web server; and
transmitting, in the web server, the location based service to the portable terminal according to the updated present location information.

10. The method of claim 9, further comprising receiving, in the portable terminal, an application program for indoor location recognition from a portal server interworking with the web server.

11. The method of claim 9, wherein the transmitting of the measured results to the portable terminal includes:
measuring the movement distance by counting the revolutions of a wheel of the indoor transport unit; and
measuring the movement direction using an geomagnetic sensor included in an indoor navigation device.

12. An indoor location recognition method for recognizing a location of a user in an indoor space in order to provide a location based service, the method comprising:
recognizing, in a portable terminal of the user, a location identification tag disposed at any location of the indoor space to transmit the identifier information to a web server providing the location based service;
transmitting, in the web server, present location information of the portable terminal to the portable terminal in response to the identifier information;
measuring, in an indoor navigation device installed in an indoor transport unit moving in the indoor space by the user possessing the portable terminal, a movement distance and a movement direction of the indoor transport unit and transmitting the measured results to the portable terminal;
updating, in the portable terminal, the present location using the present location information and the measured results and transmitting the updated present location information to the web server; and
transmitting, in the web server, the location based service to the portable terminal according to the updated present location information.
